(19) United States
(12) Patent Application Publication
(10) Pub. No.: US 2016/0121742 A1
(43) Pub. Date: May 5, 2016

(54) SYSTEM AND METHOD FOR CONTROLLING CHARGING BATTERY OF HYBRID VEHICLE

(71) Applicant: Hyundai Motor Company, Seoul (KR)

(72) Inventors: Hyoung Jun Cho, Seoul (KR); Sang Hoon Moon, Gyeonggi-do (KR); Yeon Ho Kim, Gyeonggi-do (KR); Kyoung Bum Kim, Gyeonggi-do (KR); Sang Hwa Do, Gyeonggi-do (KR); Woong Chan Chae, Gyeonggi-do (KR); Dong Yeon Han, Seoul (KR); Jung Shik Kim, Seoul (KR)

(21) Appl. No.: 14/865,481

(22) Filed: Sep. 25, 2015

(30) Foreign Application Priority Data
Nov. 5, 2014 (KR) 10-2014-0152616

(51) Int. Cl. B60L 11/18; B60W 20/00; B60K 6/20

(52) U.S. Cl. CPC B60L 11/1814; B60K 6/20; B60W 20/00; Y10S 903/93

(57) ABSTRACT

A system and method for controlling charging a battery of a hybrid vehicle are provided that charge the battery using a hybrid starter generator during limiting motor power for high temperature protection of the driving motor. Accordingly, a frequency of a driving motor reaching a power limitation due to high temperature protection is minimized while a driving time and frequency of a driving motor is reduced, by charging the battery by driving the hybrid starter generator (HSG) when a temperature of the driving motor reaches a predetermined level or greater due to a frequent driving of the driving motor while driving the hybrid vehicle.

### CROSS-REFERENCE TO RELATED APPLICATION

This application claims under 35 U.S.C. §119(a) the benefit of Korean Patent Application No. 10-2014-0152616 filed on Nov. 5, 2014, the entire contents of which are incorporated herein by reference.

### BACKGROUND

(a) Technical Field

The present disclosure relates to a system and method for controlling the charging of a battery of a hybrid vehicle. More particularly, it relates to a system method for controlling the charging of a battery of a hybrid vehicle capable of charging the battery using a hybrid starter generator during limiting motor power for high temperature protection of the driving motor.

(b) Background Art

A hybrid vehicle is a type of vehicle that reduces exhaust gas and improves fuel efficiency by utilizing an engine and a motor as a power source and is equipped with a power transfer system which separately transfers engine or motor power to a driving wheel or transfers both the engine power and the motor power to the driving wheel to drive the vehicle.

Referring to FIG. 3, the power transfer system for a hybrid vehicle of the related art includes an engine 10 and a motor 12 arranged in series, an engine clutch 13 disposed between the engine 10 and the motor 12 and configured to transfer or interrupt engine power, an automatic transmission 14 configured to shift motor power or the motor power and the engine power to a driving wheel and output the shifted power, a hybrid starter generator (HSG) 16 connected to a crank pulley of the engine to perform engine starting and generation, an inverter 18 configured to operate the motor and the generation, a high voltage battery 20 chargeably and dischargeably connected to the inverter to provide power to the motor 12, and the like.

The power transfer system for a hybrid vehicle is a type in which the motor is mounted at the automatic transmission side and is called a transmission mounted electric device (TMED) type. In particular, the power transfer system provides driving modes, such as an electric vehicle (EV) mode which is a pure electric vehicle mode using the motor power, a hybrid electric vehicle (HEV) mode which uses the motor as an auxiliary power source while using the engine as a main power source, and a regenerative braking (RB) mode which recovers braking and inertial energy of the vehicle through generation from the motor during driving by the braking or the inertia of the vehicle and charges the recovered braking and inertia energy of the vehicle in the battery.

During high speed driving of the hybrid vehicle (e.g., driving at a predetermined speed) and driving in a high torque state of the motor, an output limitation to protect various components from high temperature due to the temperature increase of the motor is operated. For example, as illustrated in a portion represented by a circle in FIG. 2, when the temperature of the motor is equal to or greater than about 170° C., the output limitation of the motor is operated.

The phenomenon of a reduction in acceleration of the vehicle, a reduction in power performance, and the like during the output limitation of the motor may inevitably occur, and thus driving desire of a driver may not be satisfied. In other words, when the vehicle is driven in the EV mode or the temperature of the motor is increased due to the continuous driving at a substantially high load and the regenerative generation in the HEV mode, the motor output for high temperature protection is limited. Therefore, even though the accelerator pedal is engaged, the acceleration performance of the vehicle is reduced.

Therefore, a method for protecting the high temperature of the motor of the hybrid electric vehicle (HEV) and a plug-in hybrid electric vehicle (PHEV) and maintaining power performance at the time of the power by the motor for high temperature protection is required.

The above information disclosed in this section is merely for enhancement of understanding of the background of the invention and therefore it may contain information that does not form the prior art that is already known in this country to a person of ordinary skill in the art.

### SUMMARY

The present invention provides a system and method for controlling charging of a battery of a hybrid vehicle capable of minimizing a frequency that a driving motor reaches a power limitation due to high temperature protection while reducing a driving time and frequency of a driving motor, by charging the battery by driving the hybrid starter generator (HSG) when a temperature of the driving motor reaches a predetermined level or greater due to frequent driving of the driving motor while driving the hybrid vehicle.

In one aspect, the present invention provides a method for controlling charging of a battery of a hybrid vehicle that may include: monitoring a temperature of a driving motor while driving a hybrid vehicle; when the temperature of the driving motor is equal to or greater than “reference temperature for high temperature protection—α”, determining a current driving mode of the hybrid vehicle; when a current driving mode is an HEV mode, charging the battery by driving a hybrid starter generator connected to a crank shaft of an engine; and when the current driving mode is an EV mode, charging the battery by driving the hybrid starter generator by starting the engine.

In an exemplary embodiment, when the current driving mode is either the HEV mode or the EV mode, a control to increase an engine revolutions per minute (rpm) when power required by a driver is substantially high and reduce the engine rpm when power required by the driver is substantially low may be performed. In addition, when the temperature of the driving motor is equal to or less than “reference temperature—α” of high temperature protection, the current driving mode may be maintained. The charging of the battery by driving the hybrid starter generator may be utilized instead of using regenerative braking from the driving motor.

According to the exemplary embodiments of the present invention, it may be possible to minimize the frequency of the power limitation based on the high temperature protection logic of the driving motor while minimizing the driving of the driving motor by stopping the driving of the driving motor during the regenerative braking and charging the battery by driving the hybrid starter generator when the temperature of the driving motor approaches the reference temperature of the high temperature protection, thereby satisfying the acceleration intention of the driver, and the like.

### BRIEF DESCRIPTION OF THE DRAWINGS

The above and other features of the present invention will now be described in detail with reference to exemplary embodiments thereof illustrated in the accompanying drawings which are given hereinbelow by way of illustration only, and thus are not limitative of the present invention, and wherein:

FIG. 1 is an exemplary systematic diagram of a power transfer illustrating a power transfer flow of a hybrid vehicle according to the related art;

FIG. 2 is an exemplary control diagram illustrating that an output limitation of a motor for high temperature protection of the motor according to the related art is performed; and

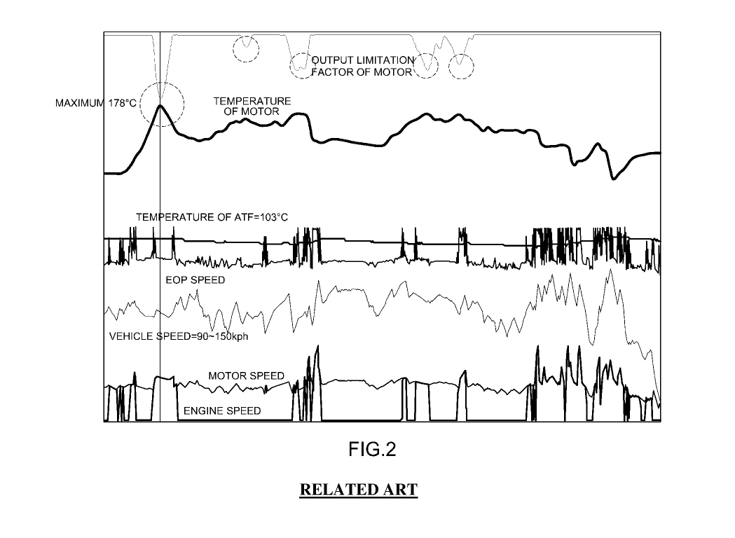

FIG. 3 is an exemplary flow chart illustrating a method for controlling charging a battery of a hybrid vehicle according to the exemplary embodiment of the present invention.

Reference numerals set forth in the Drawings includes reference to the following elements as further discussed below:
10: engine
12: motor
13: engine clutch
14: automatic transmission
16: HSG
18: inverter
20: battery

It should be understood that the appended drawings are not necessarily to scale, presenting a somewhat simplified representation of various exemplary features illustrative of the basic principles of the invention. The specific design features of the present invention as disclosed herein, including, for example, specific dimensions, orientations, locations, and shapes will be determined in part by the particular intended application and use environment. In the figures, reference numbers refer to the same or equivalent parts of the present invention throughout the several figures of the drawing.

### DETAILED DESCRIPTION

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles (e.g. fuels derived from resources other than petroleum). As referred to herein, a hybrid vehicle is a vehicle that has two or more sources of power, for example both gasoline-powered and electric-powered vehicles.

Although exemplary embodiment is described as using a plurality of units to perform the exemplary process, it is understood that the exemplary processes may also be performed by one or plurality of modules. Additionally, it is understood that the term controller/control unit refers to a hardware device that includes a memory and a processor. The memory is configured to store the modules and the processor is specifically configured to execute said modules to perform one or more processes which are described further below.

Furthermore, control logic of the present invention may be embodied as non-transitory computer readable media on a computer readable medium containing executable program instructions executed by a processor, controller/control unit or the like. Examples of the computer readable mediums include, but are not limited to, ROM, RAM, compact disc (CD)-ROMs, magnetic tapes, floppy disks, flash drives, smart cards and optical data storage devices. The computer readable recording medium can also be distributed in network coupled computer systems so that the computer readable media is stored and executed in a distributed fashion, e.g., by a telematics server or a Controller Area Network (CAN).

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items.

Unless specifically stated or obvious from context, as used herein, the term “about” is understood as within a range of normal tolerance in the art, for example within 2 standard deviations of the mean. “About” can be understood as within 10%, 9%, 8%, 7%, 6%, 5%, 4%, 3%, 2%, 1%, 0.5%, 0.1%, 0.05%, or 0.01% of the stated value. Unless otherwise clear from the context, all numerical values provided herein are modified by the term “about.”

Hereinafter reference will now be made in detail to various exemplary embodiments of the present invention, examples of which are illustrated in the accompanying drawings and described below. While the invention will be described in conjunction with exemplary embodiments, it will be understood that present description is not intended to limit the invention to those exemplary embodiments. On the contrary, the invention is intended to cover not only the exemplary embodiments, but also various alternatives, modifications, equivalents and other embodiments, which may be included within the spirit and scope of the invention as defined by the appended claims.

Hereinafter, exemplary embodiments of the present invention will be described in detail with reference to the accompanying drawings.

As described above, a main driving motor is driven during the assistance of driving power of a hybrid vehicle and driving of the hybrid vehicle in an EV mode and the driving motor is frequently driven by generation of regenerative braking during deceleration or turning off of an accelerator pedal or driving a main driving motor. Therefore, a device for cooling the driving motor to respond to the frequent driving of the driving motor is required. For this purpose, the driving motor is equipped in an automatic transmission and therefore a method for cooling a driving motor by circulating an automatic transmission fluid (ATF) has previously been used, but the automatic transmission fluid cools the driving motor in addition to cooling the automatic transmission and therefore is relatively disadvantageous in cooling performance .

Meanwhile, a hybrid starter generator (HSG), which is a type of motor, is connected to a crank pulley of an engine to perform engine start and the generation has an advantage of high temperature protection by using a water cooling system along with an inverter for operating the driving motor.

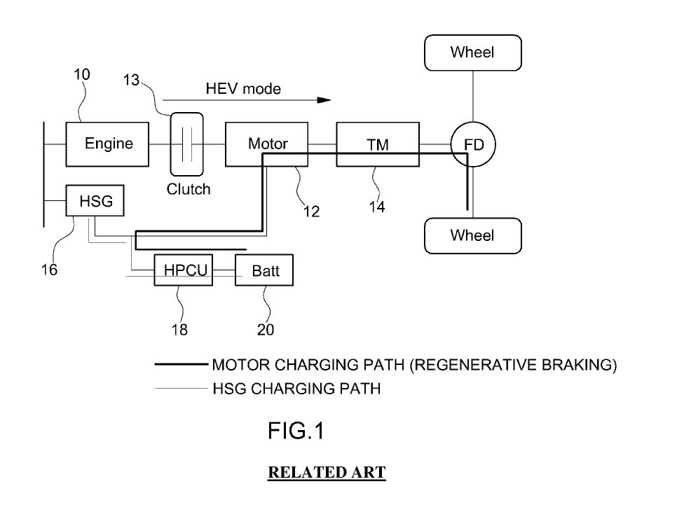

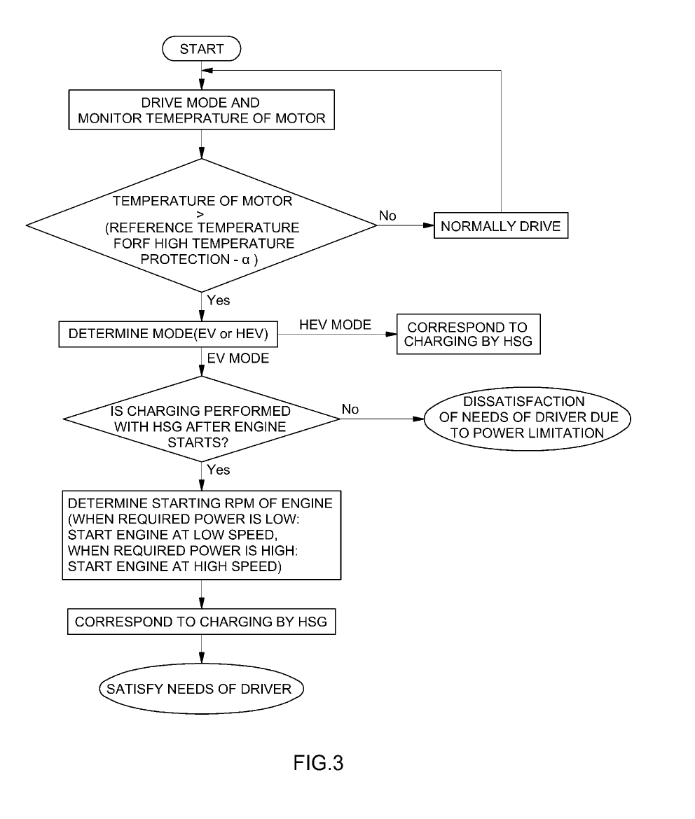

Therefore, the present invention performs the charging of the battery by driving the hybrid starter generator (HSG) when the temperature of the driving motor for driving the hybrid vehicle reaches a predetermined level or greater to minimize a frequency of the driving motor reaching a power limitation for high temperature protection while reducing a driving time and frequency of the driving motor. In particular, the method for controlling charging a battery of a hybrid vehicle according to the exemplary embodiment of the present invention will be described with reference to the accompanying FIGS. 1 and 3.

Particularly, the charging of the battery may be performed during regenerative braking of the driving motor and when an output limitation for high temperature protection of a motor is expected, the charging of the battery may be performed by driving the hybrid starter generator instead of driving the driving motor to prevent the output of the driving motor from being limited. In other words, the driving motor is connected to a driving shaft (tire) to recover energy generated during the regenerative braking, and the hybrid starter generator may not recover energy generated during the regenerative braking since a belt is connected to the engine but the driving motor continuously generates heat even during power generation of the driving motor for recovering the energy during the regenerative braking. Accordingly, the charging of the battery may be executed by the power generation driving of the hybrid starter generator when necessary by determining importance of the high temperature protection and the energy recovery efficiency of the regenerative braking.

However, the hybrid starter generator may be driven at a sufficient level to generate power to protect the high temperature of the driving motor. Accordingly, the method may include monitoring the temperature of the driving motor while driving the hybrid vehicle (S101). The temperature may be monitored using a temperature sensor. Further, the temperature of the driving motor may be compared with a reference temperature of the high temperature protection (S102). Notably, the processes described herein may be performed by a controller having a processor and a memory.

The temperature of the driving motor may be compared with “reference temperature of the high temperature protection—α”. Therefore, when the temperature of the driving motor already exceeds the reference temperature of the high temperature protection, the output limitation may be performed by a high temperature protection logic, and therefore the temperature of the driving motor may be compared with the “reference temperature—αof the high temperature protection” which may approach the reference temperature of the high temperature protection.

For the comparison result, when the temperature of the driving motor reaches the “reference temperature of the high temperature protection—α”, a driving mode using the driving motor of the hybrid vehicle may be maintained. Further, when the temperature of the driving motor is equal to or greater than “reference temperature of the high temperature protection—α”, a current driving mode of the hybrid vehicle may be determined (S103).

When the current driving mode is an HEV mode, that is, the motor is used as auxiliary power source while the engine is used as main power source, the charging of the battery may be performed by driving the hybrid starter generator connected to a crank shaft of the engine (S104). Additionally, when the current driving mode is an EV mode, that is, the vehicle is driven by the power of the driving motor, whether to start the engine may be determined to drive the hybrid starter generator or to maintain the EV mode by continuously driving the driving motor (S105).

When the EV mode is maintained by driving the driving motor, the driving motor exceeds the reference temperature of the high temperature protection and thus the power limitation of the driving motor may be performed by the high temperature protection logic (S106), thus not complying with a driver intention.

Therefore, according to the exemplary embodiment of the present invention, when the vehicle is driven in the EV mode when the driving motor approaches the reference temperature of the high temperature protection, that is, the driving motor is equal to or greater than the “reference temperature of the high temperature protection—α”, the engine may be started (S106). In other words, the engine may be started by driving the hybrid starter generator and the hybrid starter generator may be configured to generate power based on the starting of the engine to charge the battery.

Meanwhile, when the engine starts, rpm may be adjusted. In other words, when the power required by the driver is substantially high (e.g., equal to or greater than about 10 kW), the engine rpm may be increased and when the power required by the driver is substantially low (e.g., equal to or less than about 5 kW), the charging of the battery may be performed by driving the hybrid starter generator connected to the crank shaft of the engine while the engine rpm is reduced.

The charging of the battery by power generation of the hybrid starter generator may replace the power generation during the regenerative braking of the driving motor. In other words, when the driving motor may be configured to charge the battery during regenerative braking, and when the output limitation for the high temperature protection of the motor is expected, the hybrid starter generator may be driven instead of the driving motor to charge the battery to prevent the driving motor from exceeding the reference temperature of the high temperature protection, to thus minimize the output limitation of the driving motor, thereby resolving the dissatisfaction of the driver's acceleration intention due to the output limitation of the driving motor.

Since the driving motor may be configured to continuously generate heat even during the power generation of the driving motor for recovering the energy during the regenerative braking, the driving of the driving motor for the regenerative braking may stop when necessary and the charging of the battery may instead be performed by driving power generation of the hybrid starter generator, by determining the importance of the high temperature protection and the energy recovery efficiency of the regenerative braking to prevent the driving motor from exceeding the reference temperature of the high temperature protection. Accordingly, the output limitation of the driving motor may be minimized, thereby resolving the dissatisfaction of the driver's acceleration intention due to the output limitation of the driving motor.

The invention has been described in detail with reference to exemplary embodiments thereof. However, it will be appreciated by those skilled in the art that changes may be made in these exemplary embodiments without departing from the principles and spirit of the invention, the scope of which is defined in the appended claims and their equivalents.

What is claimed is:

1. A method for controlling charging of a vehicle battery, comprising:
monitoring, by a controller, a temperature of a driving motor while a vehicle is driven;
when the temperature of the driving motor is equal to or greater than “reference temperature for high temperature protection—α”, determining, by the controller, a current driving mode of the vehicle;
when a current driving mode is hybrid electric vehicle (HEV) mode, charging, by the controller, the battery by driving a hybrid starter generator connected to a crank shaft of an engine; and
when the current driving mode is an electric vehicle (EV) mode, charging, by the controller, the battery by driving the hybrid starter generator by starting the engine.

2. The method of claim 1, wherein an engine revolutions per minute (rpm) is increased when power required by a driver is substantially high and the engine rpm is reduced when power required by the driver is substantially low.

3. The method of claim 1, wherein when the temperature of the driving motor is equal to or less than “reference temperature for high temperature protection—α”, the current driving mode is maintained.

4. The method of claim 1, wherein the charging of the battery by driving the hybrid starter generator is performed instead of regenerative braking of the driving motor.

5. A system for controlling charging of a vehicle battery, comprising:
a memory configured to store program instructions; and
a processor configured to execute the program instructions, the program instructions when executed configured to:
monitor a temperature of a driving motor while a vehicle is driven;
determine a current driving mode of the vehicle when the temperature of the driving motor is equal to or greater than “reference temperature for high temperature protection—α”;
charge the battery by driving a hybrid starter generator connected to a crank shaft of an engine when a current driving mode is hybrid electric vehicle (HEV) mode; and
charge the battery by driving the hybrid starter generator by starting the engine when the current driving mode is an electric vehicle (EV) mode.

6. The system of claim 5, wherein an engine revolutions per minute (rpm) is increased when power required by a driver is substantially high and the engine rpm is reduce when power required by the driver is substantially low.

7. The system of claim 5, wherein when the temperature of the driving motor is equal to or less than “reference temperature for high temperature protection—α”, the current driving mode is maintained.

8. The system of claim 5, wherein the charging of the battery by driving the hybrid starter generator is performed instead of regenerative braking of the driving motor.

9. A non-transitory computer readable medium containing program instructions executed by a controller, the computer readable medium comprising:
program instructions that monitor a temperature of a driving motor while a vehicle is driven;
program instructions that determine a current driving mode of the vehicle when the temperature of the driving motor is equal to or greater than “reference temperature for high temperature protection—α”;
program instructions that charge the battery by driving a hybrid starter generator connected to a crank shaft of an engine when a current driving mode is hybrid electric vehicle (HEV) mode; and
program instructions that charge the battery by driving the hybrid starter generator by starting the engine when the current driving mode is an electric vehicle (EV) mode.

10. The non-transitory computer readable medium of claim 9, wherein an engine revolutions per minute (rpm) is increased when power required by a driver is substantially high and the engine rpm is reduced when power required by the driver is substantially low.

11. The non-transitory computer readable medium of claim 9, wherein when the temperature of the driving motor is equal to or less than “reference temperature for high temperature protection—α”, the current driving mode is maintained.

12. The non-transitory computer readable medium of claim 9, wherein the charging of the battery by driving the hybrid starter generator is performed instead of regenerative braking of the driving motor.
